(19) United States
(12) Patent Application Publication
(10) Pub. No.: US 2022/0344139 A1
(43) Pub. Date: Oct. 27, 2022

(54) MASS SPECTROMETER

(71) Applicant: SHIMADZU CORPORATION, Kyoto-shi, Kyoto (JP)

(72) Inventors: Shingo FUJIOKA, Kyoto-shi, Kyoto (JP); Hikaru ISHIHARA, Kyoto-shi, Kyoto (JP)

(73) Assignee: SHIMADZU CORPORATION, Kyoto-shi, Kyoto (JP)

(21) Appl. No.: 17/427,137

(22) PCT Filed: Feb. 19, 2019
(86) PCT No.: PCT/JP2019/006120

§ 371 Date: Feb. 16, 2022

(51) Int. Cl. H01J 49/04; H01J 49/16; H01J 49/42

(52) U.S. Cl. CPC H01J 49/0413; H01J 49/165; H01J 49/0431; H01J 49/4215

(57) ABSTRACT

A mass spectrometer includes: a probe having an electric conductivity; a probe moving unit configured to move the probe; a high voltage application unit configured to apply a high voltage to the probe located at an ion generation position where the tip of the probe is apart from the sample, so as to generate an ion from the sample adhered to the probe, the ion originating from a component in the sample; and a sample holding unit that includes a sample holder having a plurality of concave portions, each configured to hold the sample, and a base configured to hold the sample holder in a removable manner, the base including a mechanical element configured to move the sample holder in order to sequentially move each of the plurality of concave portions of the sample holder to the sample collection position.

### TECHNICAL FIELD

The present invention relates to a mass spectrometer employing a probe electrospray ion source.

### BACKGROUND ART

Various ionization methods have conventionally been proposed and put to practical use for ionizing a component in a sample as a measurement target in a mass spectrometer. As a type of ionization method where ionization is performed in an ambience of atmospheric pressure, an electrospray ionization (ESI) method is commonly known. As one of the ionization methods which employ the ESI, a probe electrospray ionization (PESI) method has been drawing attention in recent years.

As disclosed in Patent Literature 1, a probe electrospray ion source (hereinafter, referred to as a PESI ion source) includes: an electrically conductive probe; a position-changing unit for changing the position(s) of one or both of the probe and a sample so as to make the sample adhere to the tip of the probe; and a high voltage generator for applying a high voltage to the probe with the sample attached on the tip of the probe. In a measurement, the position-changing unit is operated to change the position(s) of one or both of the probe and the sample so that the tip of the probe comes in contact with the sample and makes the sample adhere to the tip surface of the probe. The position-changing unit is subsequently operated to separate the probe from the sample, and a high voltage is applied from the high voltage generator to the probe. Then, a strong electric field acts on the sample adhered to the tip of the probe and induces the electrospray phenomenon, which causes the molecules of the sample to be detached and ionized.

Typically, ionization utilizing the electrospray phenomenon is higher in ionization efficiency than other methods, for example, an ionization by laser light irradiation. Thus, in the PESI ion source, molecules of a small amount sample are efficiently ionized. Another advantage is that, in PESI, a biological sample (e.g., blood or bone marrow fluid) collected from a subject or the like in a small amount need not be subjected to pretreatment such as dissolution or dispersing, but it can be directly ionized.

### CITATION LIST

### Patent Literature

Patent Literature 1: WO 2017/154153 A

### Non Patent Literature

Non Patent Literature 1: “DPiMS-2020 Probe Electrospray Ionization Mass Spectrometer—Direct Probe Ionization-MS”, [online], Shimadzu Corporation, [searched on Feb. 14, 2019], Internet <URL: https://www.an.shimadzu.co.jp/ms/dpims/index.htm>.

### SUMMARY OF INVENTION

### Technical Problem

In the PESI ion source, the sample needs to be dissolved in a solvent in principle. Thus, usually, a sample plate provided with a dip for holding a liquid sample is used. In a conventional mass spectrometer equipped with a PESI ion source (hereinafter may be called a “PESI-MS”) disclosed in Non Patent Literature 1 or others, a disposable sample plate made of plastic is used mainly in order to prevent contamination.

However, with a PESI-MS of this conventional type, every time each sample is analyzed, the operator is required to replace the sample plate, resulting in low analysis throughput. Further, when a large number of samples are subjected to analysis, a large number of sample plates should be prepared, so that it is difficult to reduce running cost of the analysis.

In view of the respects described above, an object of the present invention is to provide a PESI-MS configured to improve the analysis throughput and reduce the running cost.

### Solution to Problem

A mass spectrometer according to an aspect of the present invention includes:

a probe having an electric conductivity;

a probe moving unit configured to move the probe in a top-to-down direction between a sample collection position where a tip of the probe is brought into contact with a sample located at a predetermined position and an ion generation position where the tip of the probe is apart from the sample, so as to cause the sample to be adhered to the tip of the probe;

a high voltage application unit configured to apply a high voltage to the probe located at the ion generation position, so as to generate an ion from the sample adhered to the probe, the ion originating from a component in the sample; and

a sample holding unit that includes a sample holder having a plurality of concave portions each configured to hold the sample, and a base configured to hold the sample holder, the base including a mechanical element configured to move the sample holder in order to sequentially move each of the plurality of concave portions of the sample holder to the sample collection position.

### Advantageous Effects of Invention

With a mass spectrometer according to the present invention, it is possible to hold different samples in the plurality of concave portions of the sample holder. Further, the mechanical element included in a base operates to move the sample holder so that each of the plurality of concave portions of the sample holder is sequentially moved to the sample collection position where, when the probe is lowered, the tip of the probe comes in contact with the sample.

Accordingly, with the mass spectrometer according to the present invention, it is possible to sequentially analyze a plurality of samples without replacing the sample holder or the sample holding unit including the sample holder. With this configuration, it is possible to reduce workload required of an operator to replace a sample plate, and thus possible to enhance analysis throughput.

Further, when a large number of the samples are subjected to analysis, a less number of sample holders are needed compared with a conventional mass spectrometer. Thus, when the sample holders are disposable, running cost of the analysis is effectively reduced.

Still further, with the mass spectrometer according to the present invention, the sample holder is designed to be removable from the base, while being held by the base. Thus, even when the sample holder, with which the sample has been in contact, needs to be reused, the sample holder is easily washed and/or sterilized. With this configuration, the mass spectrometer is highly maintainable, and in this respect too, the running cost of the analysis is reduced.

### BRIEF DESCRIPTION OF DRAWINGS

FIG. 1 is a schematic configuration diagram of a PESI-MS according to an embodiment of the present invention.

FIG. 2 is a configuration diagram of a main part of the PESI-MS of this embodiment, the main part including an ion source as a major part.

FIG. 3A is a top plan view of a base portion of a sample plate in the PESI-MS of this embodiment; and FIG. 3B is a sectional view of the base portion of the sample plate, the sectional view taken along line A-AA in FIG. 3A.

FIG. 4A is a top plan view of a turret portion of the sample plate in the PESI-MS of this embodiment; and FIG. 4B is a sectional view of the turret portion of the sample plate, the sectional view taken along line B-BB in FIG. 4A.

FIG. 5A is a top plan view of the sample plate and a plate holder in the PESI-MS of this embodiment, the sample plate in a state of being attached to the plate holder; and FIG. 5B is a top plan view of the sample plate and the plate holder in the PESI-MS, the sample plate in a state of being removed from the plate holder.

FIG. 6A is a schematic side view of the sample plate and the plate holder in the PESI-MS of this embodiment, the sample plate in the state of being attached to the plate holder; and FIG. 6B is a schematic side view of the sample plate and the plate holder in the PESI-MS, the sample plate in the state of being removed from the plate holder.

FIG. 7 is a top plan view of a turret portion having another shape, the turret portion to be used in the PESI-MS of this embodiment.

FIG. 8A is a top plan view and FIG. 8B is a schematic sectional view of a turret portion having yet another shape, the turret portion to be used in the PESI-MS of this embodiment.

### DESCRIPTION OF EMBODIMENTS

A PESI-MS according to an embodiment of the present invention will be described below with reference to the drawings appended.

[Overall Configuration of PESI-MS of this Embodiment]

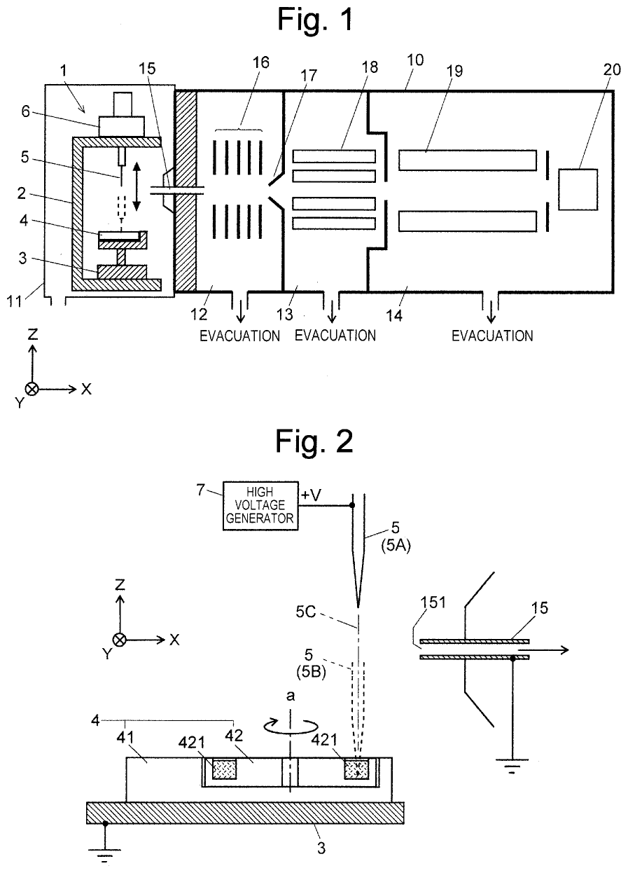

FIG. 1 is a schematic configuration diagram of a PESI-MS of this embodiment. FIG. 2 is a configuration diagram of a main part of the PESI-MS of this embodiment, the main part including a PESI ion source as a major part. For convenience of explanation, three axes/directions of an X-axis, a Y-axis, and a Z-axis, which are orthogonal to each other, are defined as shown in FIGS. 1 and 2. Here, the Z-axis direction corresponds to a top-to-bottom direction of the PESI-MS. Concurrently, an X-Y plane corresponds to a plane parallel to an installation surface where the PESI-MS is to be installed.

As shown in FIG. 1, the PESI-MS includes: an ionization chamber 11 for ionizing a component in a sample in an ambience of atmospheric pressure; a chamber 10; an analysis chamber 14 located in the chamber 10 and held in a high-vacuum ambience; a first intermediate vacuum chamber 12; and a second intermediate vacuum chamber 13. The first intermediate vacuum chamber 12 and the second intermediate vacuum chamber 13 are two intermediate vacuum chambers located between the ionization chamber 11 and the analysis chamber 14, having degrees of vacuum increased in a stepwise manner. While not shown in the drawings, the first intermediate vacuum chamber 12 is evacuated by a rotary pump, and the second intermediate vacuum chamber 13 and the analysis chamber 14 are evacuated by the rotary pump and a turbo-molecular pump.

In the ionization chamber 11, a PESI ion source 1 is arranged. The PESI ion source 1 includes a housing 2, a plate holder 3, a sample plate 4, a probe 5, and a probe moving unit 6. The plate holder 3 is fixed to the housing 2; the sample plate 4 is attached to the plate holder 3; the probe 5 is arranged above the sample plate 4 (in the Z-axis direction); and the probe moving unit 6 is fixed to the housing 2 and configured to move the probe 5 top to bottom in the Z-axis direction.

An inner space of the ionization chamber 11 communicates with that of the first intermediate vacuum chamber 12 through a heated capillary 15 of a small diameter. The inner space of the first intermediate vacuum chamber 12 communicates with that of the second intermediate vacuum chamber 13 through an orifice of a small diameter formed at an apex of a skimmer 17. In the first intermediate vacuum chamber 12 and the second intermediate vacuum chamber 13, an ion guide 16 and an ion guide 18 are respectively arranged to collect and transport ions. In the analysis chamber 14, a quadrupole mass filter 19 (as a mass separator) and an ion detector 20 are arranged.

[Schematic Configuration of PESI Ion Source]

As shown in FIG. 2, the sample plate 4 used in the PESI-MS of this embodiment includes a base portion 41 and a turret portion 42. The turret portion 42 is held by the base portion 41 to be rotatable about an axis a. As will be described in detail later, the turret portion 42 has, on its upper surface, concave portions 421 provided in plurality, and each of the concave portions 421 is configured to hold a liquid sample in a predetermined amount.

Conventionally, a sample plate for PESI is typically made of plastic, but in the PESI-MS of this embodiment, the sample plate 4 includes the base portion 41 and the turret portion 42, both of which are made of metal, such as stainless steel. In addition to the sample plate 4, the plate holder 3 and the housing 2, both of which are electrically connected to the sample plate 4, are made of metal, and the housing 2 is grounded. With this configuration, the sample plate 4 attached to the plate holder 3 also has a ground potential (0 V).

The probe 5 is held to extend in the Z-axis direction, i.e., the top-to-bottom direction, and is movable by the probe moving unit 6 in the Z-axis direction between an ion generation position 5A and a sample collection position 5B. FIG. 2 shows the ion generation position 5A with a solid line and the sample collection position 5B with a broken line. FIG. 2 shows, with a reference sign 5C, a central axis of a movement path where the probe 5 moves. Here, the probe 5 may be movable not only between the ion generation position 5A and the sample collection position 5B; the probe 5 may be movable beyond between the ion generation position 5A and the sample collection position 5B in the Z-axis direction. One of the concave portions 421 in the turret portion 42 is arranged at a position where, when the probe 5 is at the sample collection position 5B, the tip of the probe 5 comes in contact with the sample.

The heated capillary 15 has, at its inlet end, an ion intake port 151 that is located between the probe 5 (located at the ion generation position 5A) and the sample plate 4. In this example, the ion intake port 151 has its central axis extending in the X-axis direction, in other words, in a direction orthogonal to the Z-axis direction. Alternatively, the ion intake port 151 may be arranged to have the central axis extending diagonally to the Z-axis direction. The heated capillary 15 made of metal is applied with the ground potential or a predetermined potential other than the ground potential (for example, a potential having a polarity opposite to a polarity of the ion to be analyzed).

[Schematic Operation of PESI-MS of this Embodiment]

Having the configuration as described above, an operation of the PESI-MS of this embodiment will be described next.

As shown in FIG. 2, the sample plate 4, being in a state where the liquid sample to be analyzed is stored in each of the concave portions 421, is attached to the plate holder 3. When the sample plate 4 is attached at an appropriate position and when the turret portion 42 has stopped at an appropriate rotational position, one of the concave portions 421 is located at the central axis 5C of the movement path of the probe 5.

When the analysis starts, on reception of a command from a controller (not shown), the probe moving unit 6 lowers the probe 5 from the ion generation position 5A to the sample collection position 5B. The sample collection position 5B is previously, appropriately determined such that the tip (a lower end) of the probe 5 is not brought into contact with the bottom of one of the concave portions 421 of the turret portion 42 and such that the tip of the probe 5 is fully dipped in the liquid sample stored in one of the concave portions 421. Thus, when the probe 5 is lowered to the sample collection position 5B, the tip of the probe 5 is fully dipped in the liquid sample in one of the concave portions 421, and the liquid sample is adhered to the tip of the probe 5. Subsequently, the probe moving unit 6 lifts the probe 5 from the sample collection position 5B to the ion generation position 5A.

When the probe 5 is lifted to the ion generation position 5A, a high voltage generator 7 applies a high voltage predetermined to the probe 5. In this state, the high voltage has the same polarity as the polarity of the ion to be analyzed. Thus, when the polarity of the ion to be analyzed is positive, the high voltage of positive polarity+V (for example, approximately 1 kV to 10 kV at maximum) is applied to the probe 5. This causes an electric field to concentrate on the tip of the probe 5, inducing a high electric field at the tip of the probe 5 and an area surrounding the tip of the probe 5. The high electric field acts on the liquid sample adhered to a surface of the probe 5 and induces a biased electric charge to the component in the liquid sample; and this induces a electrospray phenomenon, causing the component in the liquid sample to be ionized and released. With this configuration, an ion originating from the liquid sample is generated in a vicinity of the tip of the probe 5.

Due to a pressure difference in the heated capillary 15 between the inlet end (ion intake port 151) and an outlet end, a gas flow is formed from the ionization chamber 11 to the first intermediate vacuum chamber 12 through the heated capillary 15. The ions originating from the component in the liquid sample, the ions generated as described above, are mainly carried by the gas flow, drawn into the ion intake port 151, and transported through the heated capillary 15 to the first intermediate vacuum chamber 12. Between the probe 5 and the ion intake port 151 is formed an electric field having a potential gradient to draw the ions into the ion intake port 151. The electric field facilitates the ions generated in the vicinity of the probe 5 to move to the ion intake port 151.

The ions transported to the first intermediate vacuum chamber 12 are collected by the ion guide 16 to be transported to the second intermediate vacuum chamber 13 through the orifice at the apex of the skimmer 17. The ions transported to the second intermediate vacuum chamber 13 are collected by the ion guide 18 to be transported to the analysis chamber 14, where the ions are introduced into the quadrupole mass filter 19. The quadrupole mass filter 19 includes a plurality of rod electrodes, to which a voltage corresponding to, for example, a predetermined mass-to-charge ratio (m/z), is applied. With this configuration, among the ions of various types introduced into the quadrupole mass filter 19, only an ion having the predetermined mass-to-charge ratio is allowed to pass through the quadrupole mass filter 19, and the other ions are ejected. Having passed through the quadrupole mass filter 19, the ion enters the ion detector 20, and the ion detector 20 generates and outputs an ion intensity signal corresponding to an amount of the ion that has entered.

With this configuration, in the PESI-MS of this embodiment, it is possible to obtain the ion intensity signal of the ion originating from a specific component among components of various type contained in the liquid sample that one of the concave portions 421 holds. By observing the ion intensity signal, it is possible to know whether or not the specific component is contained in the liquid sample. Further, with the ion intensity signal that reflects a contained amount of the specific component, it is possible to perform a quantitative analysis of the specific component.

[Detailed Configuration of Sample Plate]

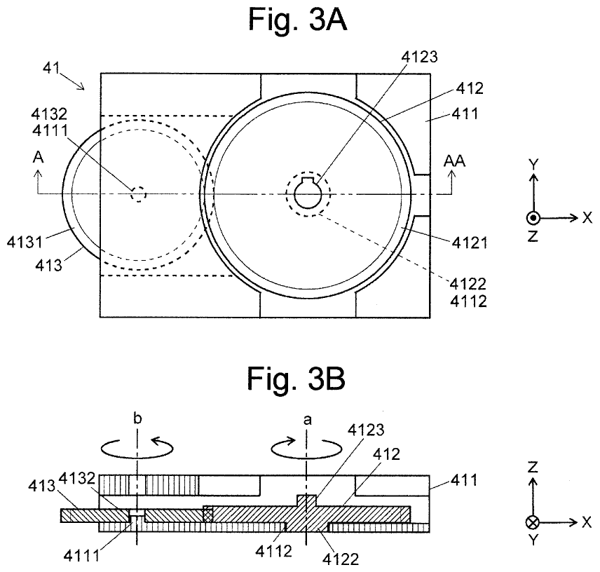

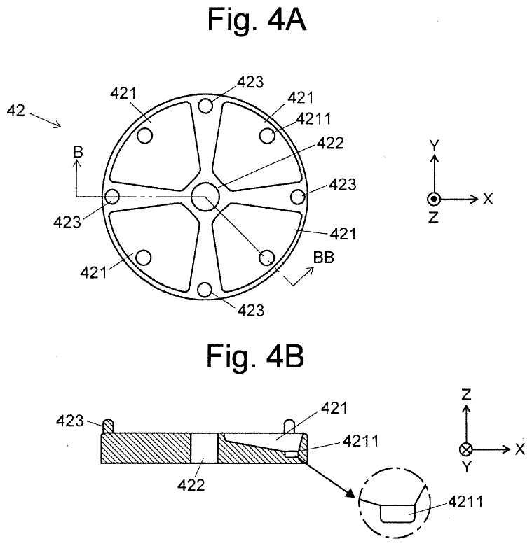

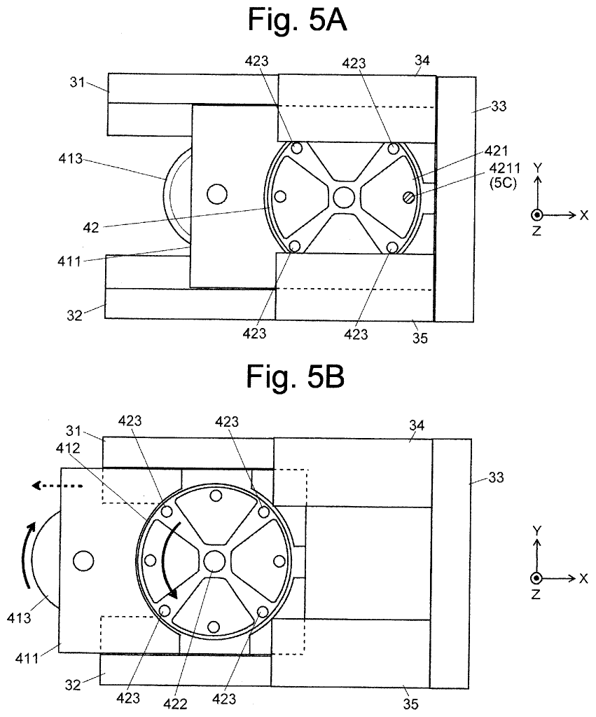

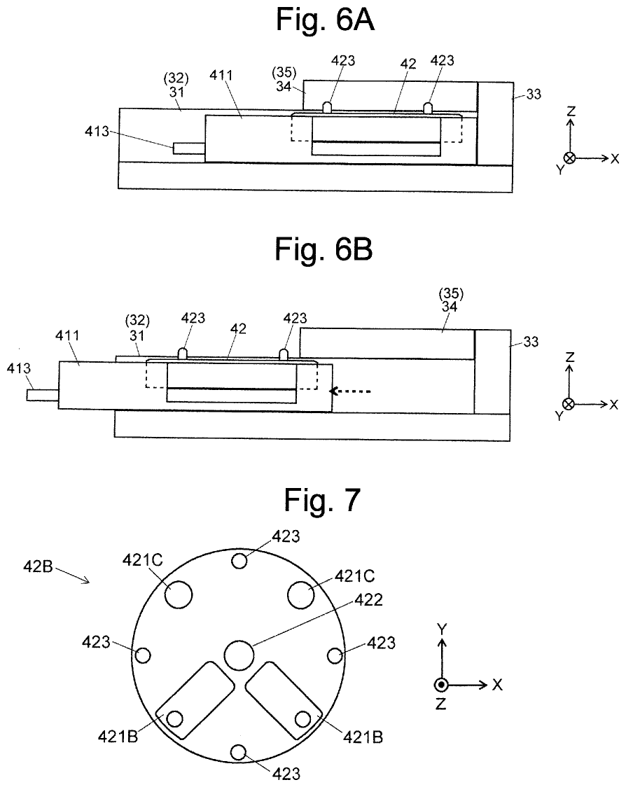

Next, a detailed configuration of the sample plate 4 will be described with reference to FIGS. 3A, 3B, 4A, 4B, 5A, 5B, 6A, and 6B. FIG. 3A is a top plan view of the base portion 41 of the sample plate 4; and FIG. 3B is a sectional view of the base portion 41, the sectional view taken along line A-AA in FIG. 3A. FIG. 4A is a top plan view of the turret portion 42 of the sample plate 4; and FIG. 4B is a sectional view of the turret portion 42, the sectional view taken along line B-BB in FIG. 4A. FIG. 5A is a top plan view of the sample plate 4 and the plate holder 3, the sample plate 4 being attached to the plate holder 3; and FIG. 5B is a top plan view of the sample plate 4 and the plate holder 3, the sample plate 4 being removed from the plate holder 3. FIG. 6A is a schematic side view of the sample plate 4 and the plate holder 4, the sample plate 4 being attached to the plate holder 3; and FIG. 6B is a schematic side view of the sample plate 4 and the plate holder 3, the sample plate 4 being removed from the plate holder 3.

As shown in FIGS. 4A and 4B, the turret portion 42 is a disk-shaped metal member, and includes a through hole 422 of a predetermined inner diameter at a center of the turret portion 42. The concave portions 421 are provided in plurality and located on the circle centered at the center of the turret portion 42. In an example of FIG. 4A, the number of the concave portions 421 is four, but the present invention is not limited to this example; as long as the concave portions 421 are provided in plurality, the number may be any. In this example, each of the concave portions 421 has substantially a fan shape in top view, and has its bottom wall inclined downward from an inner circumferential side to an outer circumferential side of the same circle. Each of the concave portions 421 includes, on its bottom wall, a liquid reservoir 4211 formed one step deeper at the outer circumferential side of the same circle. The liquid reservoir 4211 is a portion where, when the probe 5 is lowered to the sample collection position 5B, the tip of the probe 5 comes in contact with the sample. The shape of each of the concave portions 421 is not limited to this example; and thus, each of the concave portions 421 may be a simple dent having substantially a cylindrical shape, as will be described in a later example.

The turret portion 42 has, on its upper surface, four positioning pins 423, each protruding upward at the outer circumferential side of the circle. The four positioning pins 423 are arranged on the circle at a rotational angle around the center of the turret portion 42, the rotational angle of 90° being with respect to one another.

The base portion 41 shown in FIGS. 3A and 3B has a mechanical element for rotating the turret portion 42 about the axis a that is vertically oriented. In other words, the base portion 41 includes a first gear 412, a second gear 413, and a gear holder 411. The first gear 412 has its upper surface, to which the turret portion 42 is attached, and is rotatable about the axis a that is vertically oriented. The second gear 413 includes, on its outer circumferential edge, a tooth portion 4131 to engage with a tooth portion 4121 that is formed on an outer circumferential edge of the first gear 412; and the second gear 413 is rotatable about an axis b that is vertically oriented. The gear holder 411 holds these two gears, the first gear 412 and the second gear 413, in a rotatable manner.

As shown in FIGS. 3A and 3B, the first gear 412, while being housed in the gear holder 411, has its upper part fully open. On the other hand, the second gear 413 has a part (a portion at the right side in FIGS. 3A and 3B) housed in the gear holder 411, while having a portion opposite the first gear 412 (the portion at the left side in FIGS. 3A and 3B) largely protruding from a side of the gear holder 411.

The first gear 412 includes, at substantially a center of its lower surface, a first convex portion 4122 of a flat cylindrical shape; and the first convex portion 4122 is loosely fitted in a circular opening 4112 of the gear holder 411, so that the first gear 412 is rotatable about the axis a with respect to the gear holder 411. Concurrently, the first gear 412 includes, at substantially a center of its upper surface, a second convex portion 4123 of a substantially cylindrical shape; and the second convex portion 4123 includes, at a part of its circumferential surface, a notch. The second convex portion 4123 is fitted in the through hole 422 of the turret portion 42 (strictly speaking, the notch of the second convex portion 4123 of the first gear 412 is fitted in a groove of the through hole 422 of the turret portion 42). Consequently, the turret portion 42 and the first gear 412 are coupled to rotate integrally. The turret portion 42 is easily attached to and removed from the first gear 412 from above.

The second gear 413 includes, at its center, a central opening 4132 having a cylindrical shape and penetrating the gear 413 top to bottom, and the gear holder 411 includes a convex portion 4111 of a cylindrical shape; and the convex portion 4111 is loosely fitted in the central opening 4132, so that the second gear 413 is rotatable about the axis b with respect to the gear holder 411. As shown in FIG. 3B, between an upper surface of the second gear 413 and a top surface inside the gear holder 411 (that internally houses the second gear 413), a sufficient gap is provided in a thickness direction of the second gear 413. With this configuration, while having its largest portion housed in the gear holder 411, the second gear 413 is easily removed from the gear holder 411.

As described above, the tooth portion 4121 of the first gear 412 is engaged with the tooth portion 4131 of the second gear 413, and a part of the second gear 413 protrudes from the side of the gear holder 411. Thus, when an operator or others manually turns the second gear 413 (protruding from the gear holder 411) in one direction, the first gear 412 rotates in a direction opposite the one direction, and the turret portion 42 attached on the first gear 412 rotates integrally with the first gear 412. With this rotational movement, as shown in FIG. 2, it is possible to switch one of the concave portions 421, where the tip of the probe 5 enters when lowered to the sample collection position 5B, to any other one of the concave portions 421.

When the analysis is performed, the sample plate 4, including the base portion 41 and the turret portion 42 described above, is attached to the plate holder 3. As shown in FIG. 5A, the plate holder 3 includes a plate guide 31, a plate guide 32, a plate stopper 33, a rotation stopper 34, and a rotation stopper 35. A pair of the plate guides 31 and 32, each having a wall substantially an L-shaped in a section parallel to a Y-Z plane, hold the side wall and a bottom wall of the sample plate 4 in a longitudinal direction of the sample plate 4. The plane stopper 33 is configured to determine a position to which the sample plate 4 is pushed in along the pair of plate guides 31 and 32. A pair of the rotation stoppers 34 and 35 are respectively attached on the pair of plate guides 31 and 32 to extend to above the sample plate 4 that is sandwiched between the pair of plate guides 31 and 32.

When the analysis is executed, as shown in FIGS. 5A and 6A, the sample plate 4 is pushed along the pair of plate guides 31 and 32 to a position where an end portion of the sample plate 4, the end closer to the first gear, abuts the plate stopper 33. In this state, the turret portion 42 is adjusted to be at a rotational position such that two of the four positioning pins 423 are aligned in the X-axis direction. When the two of the four positioning pins 423 are positioned in this manner, the four positioning pins 423 are not in contact with the pair of rotation stoppers 34 and 35 of the plate holder 3 (or are in contact with the pair of rotation stoppers 34 and 35 while positioned at an inner side of the pair of rotation stoppers 34 and 35), and the sample plate 4 is pushed in until abutting the plate stopper 33; in other words, the sample plate 4 is pushed in such that, when the probe 5 is lowered, the probe 5 is to enter the liquid reservoir 4211 in one of the concave portions 421.

In order to cause a sufficient amount of the liquid sample to be adhered to the tip of the probe 5 lowered to the sample collection position 5B, the probe 5 needs to be operated to be lowered to collect the sample when the liquid reservoir 4211, formed one step deeper in one of the concave portions 421 of the turret portion 42, is accurately located at the central axis 5C of the movement path of the probe 5. As described above, in a state where the sample plate 4 is completely pushed into the plate holder 3, even when the turret portion 42 is caused to rotate, the four positioning pins are to abut the rotation stoppers 34 and 35. In other words, the turret portion 42 is restricted in its rotation, so that the liquid reservoir 4211 in one of the concave portions 421 is not out of position from the central axis 5C of the movement path of the probe 5.

When the analysis of the liquid sample in one of the concave portions 421 of the turret portion 42 is completed and the liquid sample in the next one of the concave portions 421 is analyzed, the operator first pulls out the sample plate 4 along the plate guides 31 and 32 by a predetermined length only. Specifically, as shown in FIGS. 5B and 6B, the operator pulls out the sample plate 4 to a position where none of the four positioning pins 423 of the turret portion 42 hits the rotation stopper 34 or the rotation stopper 35. In this state, the turret portion 42 freely rotates without any restrictions. Then, the operator rotates with fingers the second gear 413 (see a solid-line arrow in FIG. 5B) to rotate the turret portion 42 such that the liquid reservoir 4211 in the next one of the concave portions 421 (as a target) is located at the central axis 5C of the movement path of the probe 5. Practically speaking, the operator rotates the second gear 413 while checking the position for each of the four positioning pins 423, which enables the operator to determine an appropriate rotational angle for the turret portion 42. Then, when the turret portion 42 is rotated such that the liquid reservoir 4211 in the next one of the concave portions 421 (as the target) is located at the central axis 5C of the movement path of the probe 5, the sample plate 4 is pushed in again to the predetermined position, and the analysis is performed as previously done.

As described above, with the PESI-MS of this embodiment, the operator repeatedly manually rotates the turret portion 42 of the sample plate 4 for the analysis. With this configuration, it is possible to continuously analyze four types of the liquid samples without replacing the turret portion 42. When having more than four types of the liquid samples to be analyzed, the only requirement is to replace the turret portion 42 only. In a state where the sample plate 4 is removed from the plate holder 3 or in a state where, as shown in FIG. 5B, the sample plate 4 is pulled out from the plate holder 3, the turret portion may be replaced.

With a PESI-MS of conventional type, a sample plate is typically made of plastic. On the other hand, with the PESI-MS of this embodiment, the sample plate 4 is entirely made of metal. Thus, as described above, the sample plate 4 is fixed at the ground potential when the analysis is performed. When the sample plate is made of plastic, electrification is prone to occur, causing the sample plate to have an unstable potential during the analysis. On the other hand, with the PESI-MS of this embodiment, the sample plate 4 is fixed at the potential and thus, the electric field induced by the high voltage applied to the probe 5 is not disturbed. Here, the electric field in the vicinity of the probe 5 for ionization as well as the electric field for guiding the ions generated in the vicinity of the tip of the probe 5 to the ion intake port 151 is maintained in a good state. Accordingly, in addition to the ionization, the ions are introduced into the heated capillary 15 stably and highly efficiently. With this configuration, the amount of the ions introduced into the quadrupole mass filter 19 is also increased and stabilized, leading to a high level of ion detection sensitivity and data reproducibility.

The component contained in the liquid sample to be analyzed varies, and additionally, various types of solvents are used in the analysis. When the sample plate is made of plastic, with some types of the sample or the solvent, a component of plastic may be dissolved to be included into the liquid sample. On the other hand, with the PESI-MS of this embodiment, the turret portion 42, which includes the concave portions 421 holding the liquid samples, is made of metal (more particularly, in this embodiment, the turret portion 42 is made of stainless steel greater in corrosion resistance). Thus, a material of the turret portion 42 is less prone to be dissolved to be included into the liquid sample, which assures accuracy of the analysis.

The sample plate made of plastic as conventional type is typically disposable, but the sample plate 4 made of metal is designed to be reused. The PESI-MS is frequently used to analyze a biological sample (e.g., blood), so that in many cases, the sample plate is required, when being reused, to be washed and then sterilized. The sample plate 4 made of metal is heat-resistant, and may thus be subjected to sterilization at high temperature. Further, with the PESI-MS of this embodiment, the turret portion 42, including the concave portions 421 configured to hold the liquid samples, is easily removed from the base portion 41 that is not in contact with the liquid sample at normal times. Accordingly, it is easy to wash and/or sterilize only the turret portion 42.

With the PESI-MS of this embodiment, the concave portions 421 are designed to be shaped such that the turret portion 42 is easily washed. In other words, as shown in FIGS. 4A and 4B, each of the concave portions 421, configured to hold the liquid sample, has an inner wall having a round shape (arc shape). This design is applied, in each of the concave portions 421 including the liquid reservoir 4211, not only to the corner between the bottom wall and each of side walls but also to the corner between each two of the side walls. With the corners of each of the concave portions 421 formed round as described above, when the turret portion 42 is washed, the liquid sample already analyzed is less prone to remain at the corners of each of the concave portions 421. Here, the turret portion 42 is sufficiently washed, resulting in prevention of contamination.

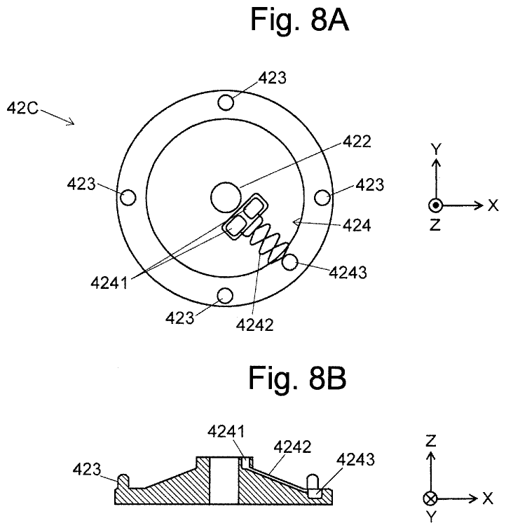

The PESI-MS of this embodiment may employ, in addition to the turret portion 42 of the sample plate 4, a turret portion having another shape than that in FIGS. 4A and 4B. Each of FIG. 7, FIG. 8A, and FIG. 8B shows a turret portion having another shape, the turret portion to be used in the PESI-MS of this embodiment.

FIG. 7 is a top plan view of a turret portion 42B having another shape. In FIG. 7, the same constituent elements as those of the turret portion 42 in FIGS. 4A and 4B are denoted with the same reference signs. The turret portion 42B includes concave portions, each having a capacity different from that of the turret portion 42 in FIGS. 4A and 4B. Specifically, for example, in FIGS. 4A and 4B, each of the concave portions 421 of the turret portion 42 has a capacity of 100 μL. However, in FIG. 7, the turret portion 42B includes a concave portion 421B having a capacity of 50 μL (a half of the capacity of the concave portion 421), and includes a concave portion 421C having a capacity of 10 μL (one fifth of the capacity of the concave portion 421B). As described above, a volume of the sample held in each of the concave portions of the turret portion may appropriately be determined. Alternatively, the turret portion may include a concave portion having a different volume from a volume of another concave portion. What is important is that, regardless of the volume of the sample, the concave portions (strictly speaking, the liquid reservoirs) are all arranged on the same circle of the turret portion. With this configuration, the constituent elements other than the turret portion may be commonly used.

FIG. 8A is a top plan view and FIG. 8B is a schematic sectional view of a turret portion 42C having yet another shape. The turret portion 42C includes, instead of the concave portions, a mixed sample measuring portion 424 including injection ports 4241, a mixed flow path 4242, and a liquid reservoir 4243. Two different types of liquid are injected into the injection ports 4241; and the two different types of liquid get mixed and flow in the mixed flow path 4242 to reach the liquid reservoir 4243 connected to an end of the mixed flow path 4242. With the turret portion 42C of this type, it is possible to perform, for example, an observation as follows: a biological sample to be analyzed is injected into one of the injection ports 4241 and a predetermined reagent is injected into the other of the injection ports 4241, and the biological sample and the reagent are mixed; then, a chemical change generated over time is repeatedly observed by the PESI-MS.

In the PESI-MS of the foregoing embodiment, the sample plate 4 is entirely made of metal, but a part of the sample plate 4 may be made of plastic, ceramic, or others. For example, even when the second gear 413 is electrically non-conductive, the gear holder 411 and the turret portion 42 have a ground potential and thus, the second gear 413 may be made of plastic or ceramic.

In the description of the foregoing embodiment, the polarity of the ion to be analyzed is positive. It is to be understood that the polarity of the ion may be negative; and in this case, the polarity of the voltage, which is applied to each of the units including the probe 5, is to be changed.

In the PESI-MS of the foregoing embodiment, the constituent elements, where the ions generated in the PESI ion source 1 are transported for mass spectrometry, are not limited to those shown in FIG. 1, and may appropriately be changed. For example, the heated capillary 15 may be replaced with a sampling cone, and the ions may be introduced into the first intermediate vacuum chamber 12 through an ion intake port formed at an apex of the sampling cone. Further, the configuration or system of the mass separator may appropriately be changed, and a tandem mass spectrometer may be used.

In the PESI-MS of the foregoing embodiment, the two gears are used as the mechanical element to sequentially move each of the plurality of concave portions, which is included in the sample plate and configured to hold the sample, to the sample collection position; however, the foregoing description is exemplary, and any appropriate mechanical element may be used. For example, a rack-and-pinion mechanism may be used such that when the operator slides the lever, the turret portion is to rotate. Alternatively, unlike the turret portion operated to rotate to cause a different one of the concave portions to reach the sample collection position, a linear movement may be used to cause the different one of the concave portions to reach the sample collection position. Further, in the PESI-MS of the foregoing embodiment, the operator manually rotates the turret portion via the gears, but alternatively, the turret portion may be rotated or slid by drive force from a drive source such as a motor included in a plate holder.

Still further, it is to be understood that the foregoing embodiment and modifications are merely illustrative, and not restrictive, of the present invention; and thus, any change, modification, addition, or correction appropriately made within the spirit of the present invention will naturally fall within the scope of claims of the present invention.

### Aspects of the Present Invention

An embodiment (in various forms) of the present invention is described above with reference to the drawings appended. Finally, various aspects of the present invention will be described.

A mass spectrometer according to a first aspect of the present invention includes:

a probe having an electric conductivity;

a probe moving unit configured to move the probe in a top-to-down direction between a sample collection position where a tip of the probe is brought into contact with a sample located at a predetermined position and an ion generation position where the tip of the probe is apart from the sample, so as to cause the sample to be adhered to the tip of the probe;

a high voltage application unit configured to apply a high voltage to the probe located at the ion generation position, so as to generate an ion from the sample adhered to the probe, the ion originating from a component in the sample; and

a sample holding unit that includes a sample holder having a plurality of concave portions, each configured to hold the sample, and a base configured to hold the sample holder, the base including a mechanical element configured to move the sample holder in order to sequentially move each of the plurality of concave portions of the sample holder to the sample collection position.

With the mass spectrometer according to the first aspect, it is possible to continuously analyze a plurality of the samples without replacing the sample holder or the sample holding unit including the sample holder. With this configuration, it is possible to reduce workload required of an operator to replace a sample plate, and thus possible to enhance analysis throughput. Further, when a large number of the samples are subjected to analysis, a less number of the sample holders are needed compared with a conventional mass spectrometer. Thus, when the sample holders are disposable, running cost of the analysis is to be effectively reduced. Still further, the sample holder, with which the sample is brought into contact, is designed to be removable from the base, so that the sample holder is easily washed to be reused.

As a second aspect of the present invention, with the mass spectrometer according to the first aspect, the sample holder is made of metal.

With the mass spectrometer according to the second aspect, the sample holder is made of metal that is typically greater in chemical resistance and corrosion resistance than plastic. Thus, regardless of a type of the sample held in the plurality of concave portions or a type of a solvent for the sample, a material of the sample holder is less prone to be dissolved to be included into the sample. With this configuration, it is possible to increase the type of the sample to be analyzed and/or the type of the solvent to be used, and thus possible to increase a range of objects to be analyzed.

As a third aspect of the present invention, with the mass spectrometer according to the first aspect or the second aspect, the sample holder is a disk-shaped turret portion including the plurality of concave portions on a circle centered at a center of the turret portion, and the mechanical element is a mechanism configured to rotate the turret portion.

As a fourth aspect of the present invention, with the mass spectrometer according to the third aspect, the mechanism includes: a first gear on which the turret portion is attached; and a second gear configured to engage with the first gear.

With the mass spectrometer according to the third and the fourth aspects, with a simple structure, the plurality of samples are sequentially moved to the sample collection position where the probe comes in contact with the sample. With this configuration, it is possible to reduce manufacturing cost of the sample holding unit and possible to downsize the sample holding unit. Further, with the mass spectrometer according to the third and the fourth aspects, the plurality of samples are sequentially moved to the sample collection position where the probe comes in contact with the sample, within a relatively limited space. With this configuration, even when an ionization chamber has a limited space, it is possible to continuously analyze the plurality of samples without replacing the sample holder or the sample holding unit.

As a fifth aspect of the present invention, with the mass spectrometer according to any one of the first to the fourth aspects,

the plurality of concave portions included in the sample holder include a concave portion having a different volume from a volume of another concave portion.

With the mass spectrometer according to the fifth aspect, it is possible to change the amount of the sample to be analyzed, and thus possible to further increase the range of the objects to be analyzed.

As a sixth aspect of the present invention, with the mass spectrometer according to any one of the first to the fifth aspects, each of the plurality of concave portions has an inner wall having a round corner.

With the mass spectrometer according to the sixth aspect, when the sample holder is washed, it is possible to easily and reliably remove the liquid sample already analyzed. With this configuration, even when the sample holder is reused, it is possible to prevent contamination from occurring and thus improve accuracy of the analysis.

### REFERENCE SIGNS LIST

1 . . . PESI Ion Source
2 . . . Housing
10 . . . Chamber
11 . . . Ionization Chamber
12 . . . First Intermediate Vacuum Chamber
13 . . . Second Intermediate Vacuum Chamber
14 . . . Analysis Chamber
15 . . . Heated Capillary
151 . . . Ion Intake Port
16, 18 . . . Ion Guide
17 . . . Skimmer
19 . . . Quadrupole Mass Filter
20 . . . Ion Detector
3 . . . Plate Holder
31, 32 . . . Plate Guide
33 . . . Plate Stopper
34, 35 . . . Rotation Stopper
4 . . . Sample Plate
41 . . . Base Portion
411 . . . Gear Holder
4111 . . . Convex Portion
4112 . . . Circular Opening
412 . . . First Gear
4121 . . . Tooth Portion
4122 . . . First Convex Portion
4123 . . . Second Convex Portion
413 . . . Second Gear
4131 . . . Tooth Portion
4132 . . . Central Opening
42, 42B, 42C . . . Turret Portion
421, 421B, 421C . . . Concave Portion
4211 . . . Liquid Reservoir
422 . . . Through Hole
423 . . . Positioning Pin
424 . . . Mixed Sample Measuring Portion
4241 . . . Injection Port
4242 . . . Mixed Flow Path
4243 . . . Liquid Reservoir
5 . . . Probe
5A . . . Ion Generation Position
5B . . . Sample Collection Position
5C . . . Central Axis of Movement Path
6 . . . Probe Moving Unit
7 . . . High Voltage Generator

1. A mass spectrometer comprising:
a probe having an electric conductivity;
a probe moving unit configured to move the probe in a top-to-down direction between a sample collection position where a tip of the probe is brought into contact with a sample located at a predetermined position and an ion generation position where the tip of the probe is apart from the sample, in order to cause the sample to be adhered to the tip of the probe;
a high voltage application unit configured to apply a high voltage to the probe located at the ion generation position, in order to generate an ion from the sample adhered to the probe, the ion originating from a component in the sample; and
a sample holding unit that includes a sample holder having a plurality of concave portions, each configured to hold the sample, and a base configured to hold the sample holder, the base including a mechanical element configured to move the sample holder in order to sequentially move each of the plurality of concave portions of the sample holder to the sample collection position.

2. The mass spectrometer according to claim 1, wherein
the sample holder is made of metal.

3. The mass spectrometer according to claim 1, wherein
the sample holder is a disk-shaped turret including the plurality of concave portions on a circle centered at a center of the turret, and
the mechanical element is a mechanism configured to rotate the turret.

4. The mass spectrometer according to claim 3, wherein
the mechanism includes: a first gear on which the turret is attached; and a second gear configured to engage with the first gear.

5. The mass spectrometer according to claim 1, wherein
the plurality of concave portions included in the sample holder include a concave portion having a different volume from a volume of another concave portion.

6. The mass spectrometer according to claim 1, wherein
each of the plurality of concave portions has an inner wall having a round corner.
